(19) United States
(12) Patent Application Publication
(10) Pub. No.: US 2005/0146760 A1
(43) Pub. Date: Jul. 7, 2005

(54) Apparatus and method for scanning specific area of document in a scanning apparatus

(75) Inventors: Jeong-rae Kim, Yongin-si (KR); Hyung-sik Byun, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronic Co., Ltd.

(21) Appl. No.: 11/004,935

(22) Filed: Dec. 7, 2004

(30) Foreign Application Priority Data
Jan. 6, 2004 (KR) 2004-636

(51) Int. Cl. H04N 1/04

(52) U.S. Cl. 358/538; 358/488

(57) ABSTRACT

An apparatus and method for scanning a specific area in a scanning apparatus are provided. The apparatus and method comprise storing a specific scanning area input by a coordinate input means of the flat-bed type scanning apparatus; checking whether scanning is started; if the specific area is scanned, measuring a document size by performing scanning and storing the same; calculating an area to be scanned from the stored scanning area and the document size; and performing scanning for an area to be scanned.

### PRIORITY

This application claims the benefit under 35 U.S.C. § 119(a) of Korean Patent Application No. 2004-00636, filed on Jan. 6, 2004, the entire contents of which is incorporated herein by reference.

### BACKGROUND OF THE INVENTION

1. Field of the Invention

The present invention relates to an apparatus and method for scanning a specific area of a document in a scanning apparatus. More particularly the present invention relates to an apparatus and method for scanning a specific area of a document in a scanning apparatus, capable of scanning a specific area of the document by inputting an area to be scanned with a document aligned so that a front side may face upward, then aligning the document with the front side down, and scanning the document.

2. Description of the Related Art

A flat-bed type scanning apparatus comprises, for example, a digital multi-function machine or a copy machine for scanning a specific area of a document, desired by a user. To realize such function of scanning a specific area of a document, many methods have been suggested.

The flat-bed type scanning apparatus has a display means capable of displaying a scanned image. A document is placed on a document stand of the scanning apparatus so that the back of the document faces upward, and a pre-scan is performed to read an image of the document, then the image of the document is displayed on the display means. Thereafter, a user checks the image of the document, designates a specific area of the document, and scans the document. Such a method is widely used when the flat-bed type scanning apparatus is connected to a computer.

The above method for scanning a specific area, however, requires a separate display means such as a computer for displaying a scanned image. Therefore, such a method cannot be applied to a copying machine.

In another example, a document is placed on a document stand of the flat-bed type scanning apparatus and a specific area to be scanned is input in form of a numerical value using a separate input means. One such example is shown in FIG. 1. FIG. 1 is a diagram illustrating a state where a document is placed on a document stand in a “Method for Reading Out Specific Area in Flat-Bed Type Multi-Function Machine” (Korea Patent Publication No. 2000-0073552) which is incorporated herein by reference.

A user places a document 1 on a document stand 3 so that the back of the document 1 may face upward as in the conventional scanning method shown in FIG. 1. Coordinates of a specific area S to be scanned in the document 1 are measured using rulers 5 and 6 prepared in the document stand 3, and then the coordinate values are input using an input means (not shown). Thereafter, according to the method described in the detailed description of Korea Patent Publication No. 2000-0073552, only a specific area of a document can be scanned.

But, according to such method, the coordinates of a specific area to be scanned should be measured with the back of a document facing with upward. If the document is not transparent and the specific area of the front side cannot be seen from the back, the document should be placed with back facing down so that the position of a specific area may be checked and the coordinates corresponding to the relevant position may be read from the ruler attached to the document stand. Therefore, it is difficult and inexact to measure coordinates of a specific area.

### SUMMARY OF THE INVENTION

The present invention has been developed in order to solve the above drawbacks and other problems associated with the conventional art. An object of the present invention is to provide an apparatus and method for scanning a specific area in a scanning apparatus, capable of specifically designating and scanning, in an easy manner, the section in a document desired by a user without using a separate image display means, by making it possible to designate a specific area to be scanned in the document with the document put on a document stand so that the front side of the document may face up.

The foregoing and other objects and advantages are substantially realized by providing an apparatus and method for scanning a specific area in a scanning apparatus, for scanning a specific area of a document put on a document stand in a flat-bed type scanning apparatus. The apparatus and method comprise storing a specific scanning area input using a coordinate input means of the flat-bed type scanning apparatus; determining whether scanning has been initiated; if the specific area is scanned, measuring a document size by performing scanning and storing of the same; calculating an area to be actually scanned, from the stored scanning area and the document size; and scanning an area to be scanned.

The step of storing a specific scanning area comprises judging whether the scanning apparatus is in a specific area designation mode; and with the document facing up and aligned to a setting reference point of the document stand, reading coordinates of a starting point and an ending point of a horizontal area and coordinates of a starting point and an ending point of a vertical area in the specific area to be scanned, from the ruler installed in the document stand, and storing the coordinates input by the coordinate input means, in an Xstart, an Xend, Ystart, Yend.

Also, the step of measuring and storing a document size comprises determining whether the scanning apparatus is in a specific area designation mode; with the back of the document facing up and aligned to a setting reference point of the document stand, storing a document image after pre-scanning the document; calculating a document size by detecting an edge from the stored document image; and storing the calculated document size in a DocXSize and a DocYSize.

Also, the step of performing actual scanning comprises moving a scanning module of the flat-bed type scanning apparatus to a scanning start position (X Scan Start Position); scanning an image of a document via the scanning module; storing a scanned image; and determining whether the scanning module is positioned at a scanning termination position.

As described above, according to the method for scanning a specific area in a scanning apparatus of the present invention, since the coordinates of a specific area to be scanned can be input with the front side of a document facing up, the coordinates can be input more accurately and easily in comparison with the conventional case in that the coordinates of a specific area are input with the document placed with the back of the document facing up.

Therefore, a user can easily scan, store, and copy the specific part of the document using the method for scanning a specific area in a scanning apparatus of the present invention even if there is no image display means in the scanning apparatus.

### BRIEF DESCRIPTION OF THE DRAWINGS

The above aspects and features of the present invention will be more apparent by describing certain embodiments of the present invention with reference to the accompanying drawings, in which:

FIG. 1 is a plan view illustrating a conventional method of a document placed on a document stand with the back of the document facing up in a scanning apparatus for scanning a specific area in a scanning apparatus is applied;

FIG. 2 is a functional block diagram of a multifunction machine to which a method for scanning a specific area in a scanning apparatus according to an embodiment of the present invention is applied;

FIG. 3 is a flowchart illustrating a method for scanning a specific area in a scanning apparatus according to an embodiment of the present invention;

FIG. 4 is a plan view illustrating a document placed on a document stand in the flat-bed type scanning apparatus in order to input a specific area to be scanned in a scanning apparatus according to an embodiment of the present invention;

FIG. 5 is a flowchart illustrating a process for storing a specific area to be scanned in the scanning apparatus according to an embodiment of the present invention;

FIG. 6 is a flowchart illustrating a process for measuring and storing a document size according to an embodiment of the present invention;

FIG. 7 is a diagram illustrating a method for calculating an area to be actually scanned according to an embodiment of the present invention, in which: (a) is a view illustrating that the document is aligned with the reference point in such a way that its front side may face up; (b) is a view illustrating that the document is aligned with the reference point by putting the document of (a), front side down in an X-direction; (c) is a view illustrating that the document is aligned with the reference point by putting the document of (a), front side down in an Y-direction;

FIG. 8 is a flowchart illustrating a process for performing actual scanning according to an embodiment of the present invention;

FIG. 9 is a flowchart illustrating a process for scanning a specific area of a document using the scanning apparatus according to an embodiment of the present invention.

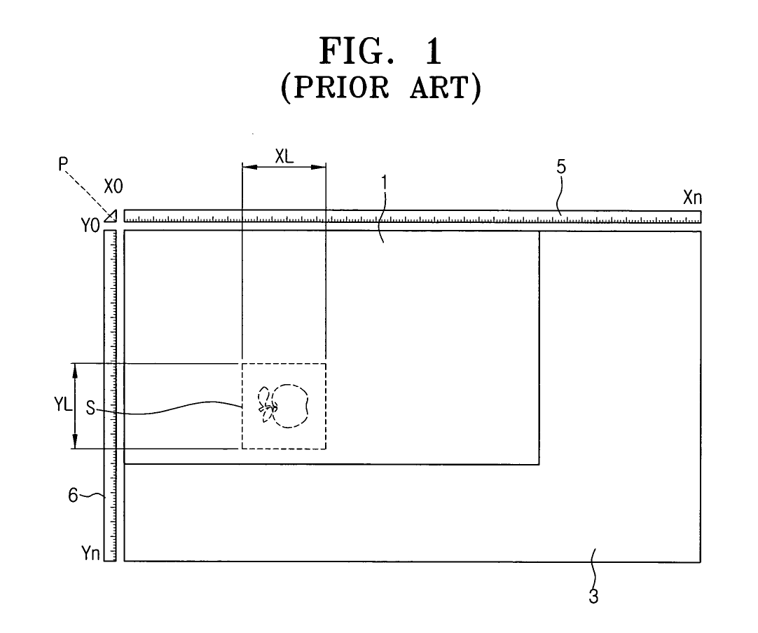

Throughout the drawings, it should be noted that the same or similar elements are denoted by like reference numerals.

### DETAILED DESCRIPTION OF THE PREFERRED EMBODIMENTS

Embodiments of the present invention will now be described in greater detail with reference to the accompanying drawings.

The matters defined in the description such as a detailed construction and elements are exemplary. Thus, it should be apparent that the embodiments of the present invention can be performed without those defined matters. Also, well-known functions or constructions are not described in detail since they would obscure the invention in unnecessary detail.

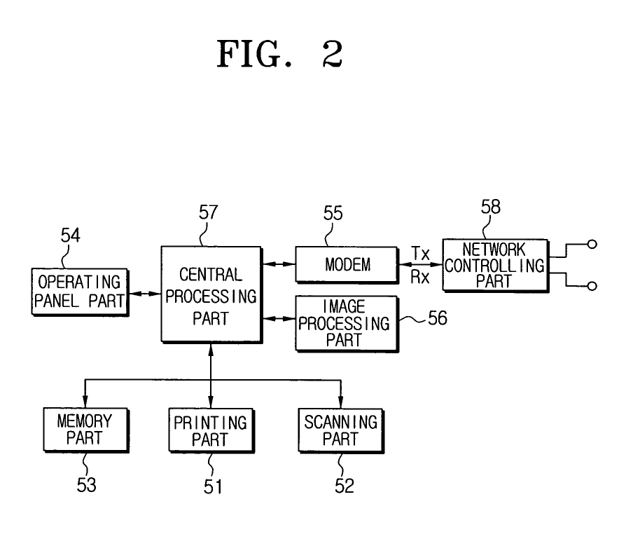

FIG. 2 illustrates an example of the flat-bed type scanning apparatus to which the method for scanning a specific area in the scanning apparatus of the present invention is applied, and shows a functional block diagram of the flat-bed type multifunction machine.

The multifunction machine includes a printing part 51; a scanning part 52; a memory part 53; an operating panel part 54; a modem 55; and a central processing part 57.

The printing part 51 prints, on a paper, data input from a computer (not shown) connected to a multifunction machine, data of a document read from the scanning part 52, or data received from the modem 55 under the control of the central processing part 57. The printing part 51 comprises a feeding part for piling/moving a paper; a printing part for printing data onto a paper; a discharging part for discharging a printed paper to the outside. For the printing part 51, a printing method using an inkjet or a printing method using a laser may be applied.

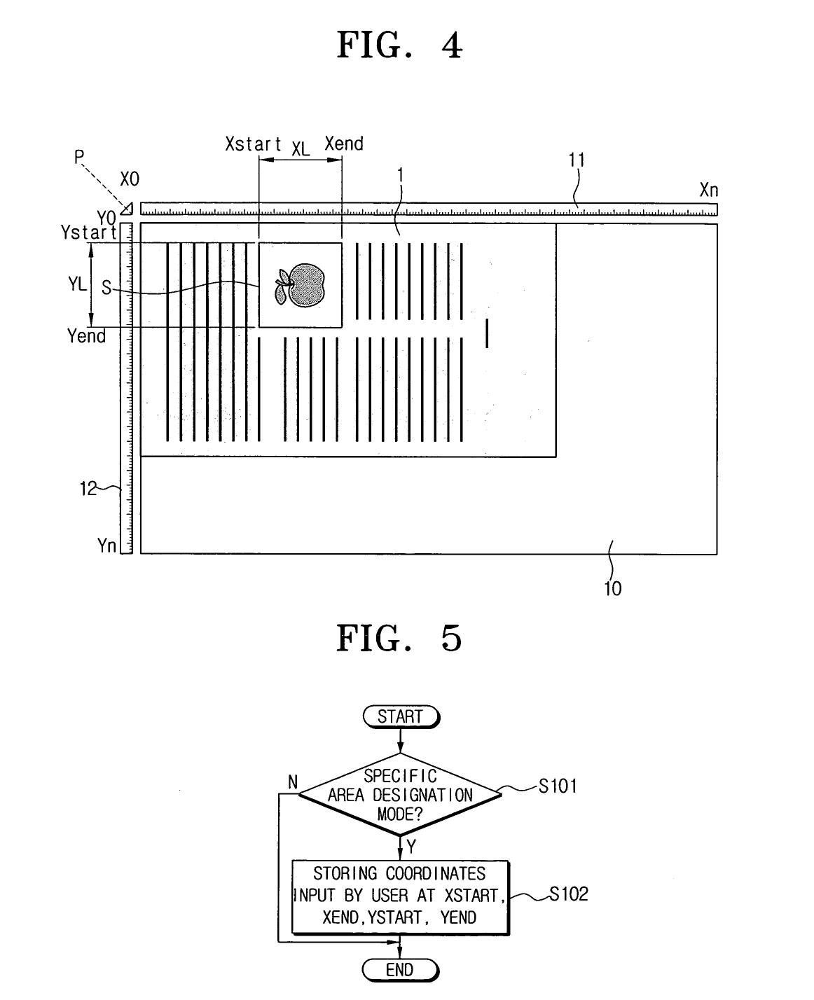

The scanning part 52 generates data to be printed by the printing part 51 or generates data to be faxed through the modem 55 by reading a document. The scanning part 52 comprises a document stand on which a document is placed comprising transparent material such as a glass plate; a scanning module installed under the document stand and is movable right and left. The scanning module has an image sensor for reading an image of a document. Also, as shown in FIG. 4, a setting reference point P for a document to be scanned is provided to one of corners of the document stand 10, and a horizontal ruler 11 and a vertical ruler 12 are installed in horizontal and vertical directions of the setting reference point P, respectively.

The memory part 53 stores operating programs and general controlling programs of the central processing part 57. Also, a variety of data input to the operating panel part 54 and a document size calculated by the central processing part 57 on the basis of the document image scanned by the scanning part 52, are stored in the memory part 53.

The operating panel part 54 has a plurality of keys required for controlling the multifunction machine, such as a numerical key for inputting a coordinate of a document, and if a predetermined key is pressed, data corresponding to the relevant key is applied to the central processing part 57. Preferably, the operating panel part 54 additionally includes an output part for displaying a message of the central processing part 57 or input key data.

By connecting to a network controlling part 58, the modem 55 is connected to a Public Switched Telephone Network (PSTN) or a key-phone network, for giving and taking a protocol or image data according to transmission and reception of fax.

The central processing part 57 generally controls the multifunction machine according to a set program. If fax data is received through the modem 55, the central processing part 57 inputs the received image data in an image processing part 56, and generates data to be printed by controlling the image processing part 56. Subsequently, the central processing part 57 transmits the generated data to be printed, to the printing part 51, then prints data onto a paper by controlling the printing part 51. If a document is copied, the central processing part 57 controls in such a way that image data obtained from scanning, by the scanning module, a document placed on the document stand of the scanning part 52 so that its back may face up, is input to the image processing part 56, and data to be printed, is generated by controlling the image processing part 56. Thereafter, the central processing part 57 transmits the generated data to be printed, to the printing part 51, and prints an image of the scanned image onto a paper by controlling the printing part 51.

Hereinafter, the method for scanning a specific area in a scanning apparatus of the present invention, applied to the multifunction machine having the foregoing construction, will be described in reference to the accompanying drawings.

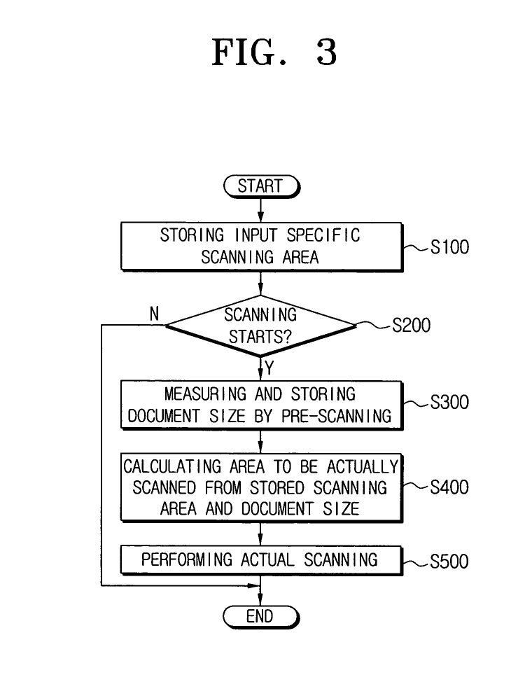

Referring to FIG. 3, the method for scanning a specific area in a scanning apparatus according to an embodiment of the present invention, mainly comprises storing a specific scanning area input by using a coordinate input means of the flat-bed type scanning apparatus at step S100; determining whether the scanning was initiated at step S200; if the specific area is scanned, measuring and storing a document size by performing pre-scanning at step S300; calculating an area to be actually scanned, from the stored scanning area and the document size at step S400; and performing actual scanning for an area to be scanned at step S500.

If the specific area to be scanned is scanned at step S100, as shown in FIG. 5, the central processing part 57 determines whether the flat-bed type scanning apparatus, i.e., the multifunction machine is set to a specific area designation mode at step S101. The specific area designation mode of the multifunction machine can be set by the key prepared in the operating panel part 54, which is a coordinate input means of the scanning apparatus.

If the multifunction machine is set to the specific area designation mode, the central processing part 57 stores as Xstart, Xend, Ystart, Yend in the memory part 53, the coordinates of a starting point and an end point of a horizontal area and the coordinates of a starting point and an end point of a vertical area of the specific area to be scanned in the document that has been input, by a user, using the coordinate input means, being the operating panel part 54 of the multifunction machine at step S102. At the moment, to read the coordinates of a specific area to be scanned in the document, a user aligns one corner of the document 1 to the setting reference point P of the document stand 10 with the document 1 put on the document stand 10 of the scanning part 52 of the multifunction machine in such a way the front side of the document 1 may face up as shown in FIG. 4. Subsequently, the coordinates of a starting point (Xstart) and an ending point (Xend) of a horizontal area (XL) of the specific area (S) to be scanned are read from the horizontal ruler 11 installed in the document stand 10, and then each coordinate value is input by the numerical key of the operating panel part 54. Also, the coordinates of a starting point (Ystart) and an ending point (Yend) of a vertical area (YL) of the specific area (S) to be scanned are read from the vertical ruler 12 installed in the document stand 10, and then each coordinate value is input by the numerical key of the operating panel part 54. If the coordinate values are input, the central processing part 57 sequentially stores the input values at Xstart, Xend, Ystart, and Yend in the memory part 53, respectively.

Next, the central processing part 57 determines whether scanning has been initiated at step S200. Starting of scanning is executed by a user pressing a scan key of the operating panel part 54.

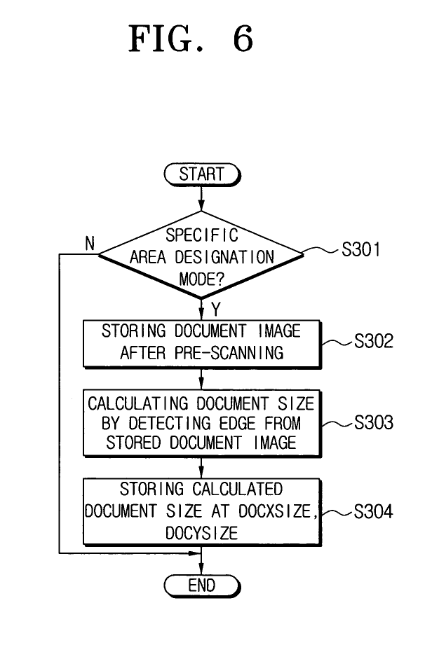

If scanning has been initiated, the central processing part 57 determines whether the multifunction machine is set to a specific area designation mode as shown in FIG. 6 at step S301. If the multifunction machine is not set to the specific area designation mode, the central processing part 57 controls the scanning part 52 to scan the whole document.

If the multifunction machine is set to the specific area designation mode, the central processing part 57 controls the scanning part 52 in such a way that the scanning module of the scanning part 52 pre-scans a document and stores an image of the document in a temporary buffer of the image processing part 56 at step S302. Subsequently, the central processing part 57 detects an edge from the stored document image using the general image analysis program, and calculates a horizontal size and a vertical size of the document using the detected edge at step S303. Then, the central processing part 57 stores the calculated horizontal and vertical sizes of the document at DocXSize and DocYSize in the memory part 53, respectively at step S304.

Next, the central processing part 57 calculates an area to be actually scanned by the scanning module, using the scanning area coordinate value, the document size, and a program for calculating an area to be actually scanned, which are stored in the memory part 53 at step S400.

An example of the program for calculating an area to be actually scanned, stored in the memory part 53, is given in the following.

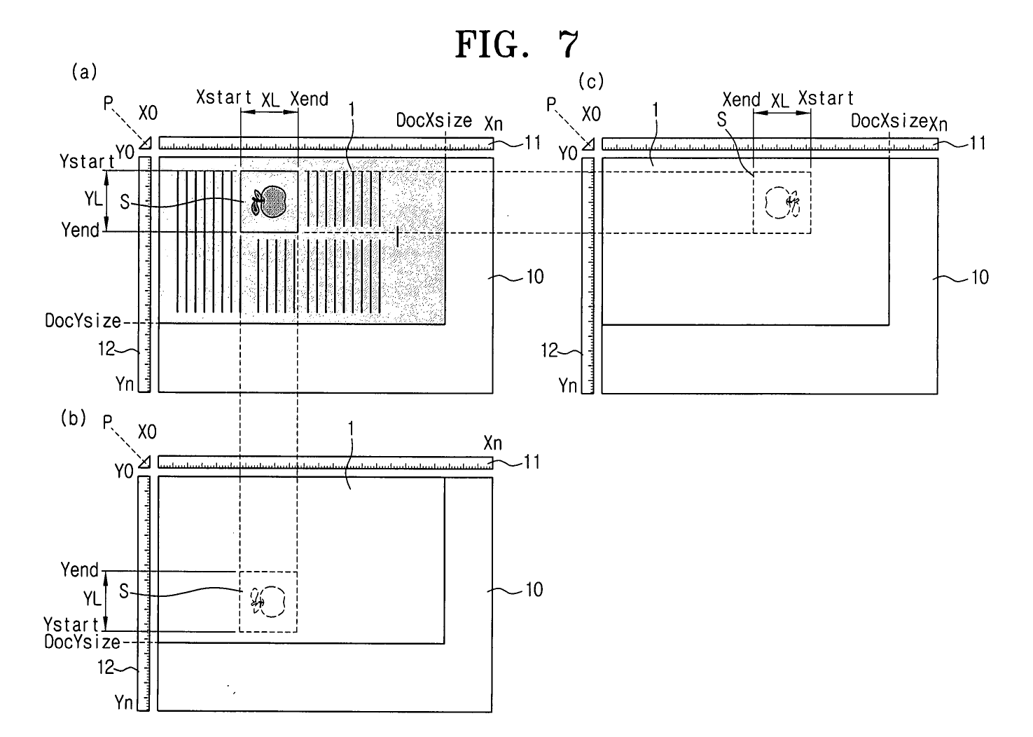

First, in case the document 1 is placed on the document stand 10 of the multifunction machine so that its front side may face up, or is placed with the front side facing down in the horizontal axis (X-axis) as shown in FIG. 7(B), the scanning start position, the horizontal area (XL) to be scanned, and the vertical area (YL) of the area (S) to be actually scanned, can be calculated with the following formula:
X Scan Start Position=Xstart
X Scan Size=Xend−Xstart
Y Scan Start Position=DocYSize−Yend
Y Scan Size=Yend−Ystart

Also, in case the document 1 is placed on the document stand 10 of the multifunction machine so that its front side may face up, or is placed with the front side facing down in the vertical axis (Y-axis) as shown in FIG. 7(C), the scanning start position, the horizontal area (XL) to be scanned, and the vertical area (YL) of the area (S) to be actually scanned, can be calculated with the following formula:
X Scan Start Position=DocXSize−Xend
X Scan Size=Xend−Xstart
Y Scan Start Position=Ystart
Y Scan Size=Yend−Ystart

Here, an X Scan Start Position and an Y Scan Start Position represent an X coordinate and an Y coordinate of the scanning start position of the area (S) to be actually scanned, respectively, and an X Scan Size and an Y Scan Size represent a size of the horizontal area (XL) and a size of the vertical area (YL) of the area to be actually scanned, and an Xstart and an Xend represent the coordinates of a starting and an ending points of the horizontal area (XL) of the specific area (S) to be scanned, which have been input by a user, in the document 1 put on the document stand 10 so that its front side may face up, and an Ystart and an Yend represent the coordinates of a starting and an ending points of the vertical area (YL) of the specific area (S) to be scanned, which have been input by a user, in the document 1 placed on the document stand 10 so that its front side may face up, and a DocXSize and a DocYSize represent a horizontal and a vertical sizes of the document 1 to be scanned, respectively.

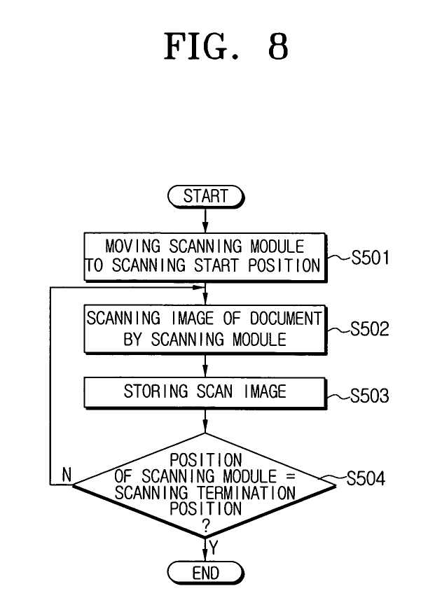

If calculation of the area (S) to be actually scanned is completed, the central processing part 57 controls the scanning part 52 such that the scanning module moves to a scanning start position as shown in FIG. 8 at step S501. If the scanning module 52 is situated in the scanning start position, the central processing part 57 controls the scanning module to scan an image of the document 1 and store the scanned image in the image processing part 56 at steps S502, and S503. The central processing part 57 can store the scanned image in the following two ways depending on the purpose of use. One way is to fill, with a white value, data for the part except the specific area (S) designated by a user, and storing the same, and the other way is to store the only data for the specific area (S) designated by a user, throwing away data for the rest of the non-designated part.

Also, while the scanning module scans the document, the central processing part 57 determines the present position of the scanning module with a predetermined interval to check whether the scanning module is situated at the scanning termination position at step S504. Here, the central processing part 57 can calculate a coordinate value of the scanning termination position, using a coordinate value of the scanning start position and the horizontal and the vertical sizes of the specific area (S) to be scanned. If the scanning module comes to the scanning termination position, the central processing part 57 terminates scanning and restores the scanning module to its original position.

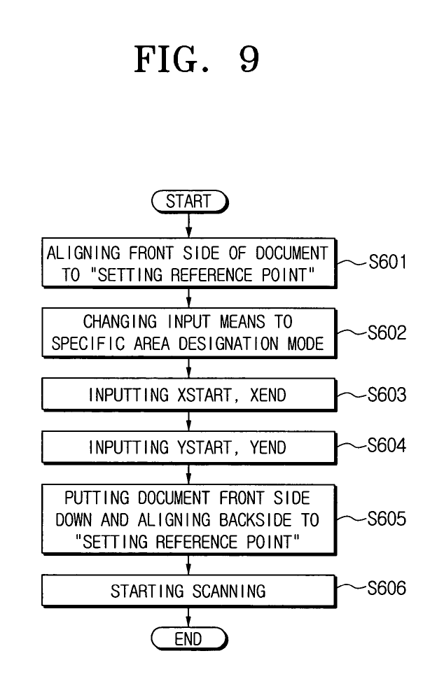

Hereinafter, the method for scanning, by a user, a specific area of a document using a scanning apparatus to which the method for scanning a specific area in the scanning apparatus of the present invention is applied, will be described with reference to accompanying FIGS. 4 and 9.

On the first place, as shown in FIG. 4, a user puts the document 1 whose specific area will be scanned, on the document stand 10 of the scanning apparatus so that its front side may face up. A user aligns the document 1 so that one corner of the document 1 is aligned to the setting reference point P of the document stand 10 at step S601.

Next, a user sets the scanning apparatus to a specific area designation mode using a coordinate input means such as the operating panel part (not shown) of the scanning apparatus at step S602.

Subsequently, a user reads coordinate values for a starting point and an ending point of the horizontal area (XL) of a specific area (S) to be scanned in the document 1 using the horizontal ruler 11 of the document stand 10, and inputs the above coordinate values for the starting and ending points into an Xstart and an Xend, respectively, using the coordinate input means at step S603. Also, a user reads coordinate values for a starting point and an ending point of the vertical area (YL) of a specific area (S) to be scanned in the document 1 using the vertical ruler 12 of the document stand 10, and inputs the above coordinate values for the starting and ending points into an Ystart and an Yend, respectively, using the coordinate input means at step S604.

If the coordinates of a specific area (S) to be scanned are input, a user puts the document 1 its front side down so that its back may face up and sets the document 1 on the document stand 10 at step S605. A user aligns the document 1 so that one corner of the overturned document 1 may be aligned to the setting reference point P of the document stand 10.

If alignment of the document 1 is completed, a user presses a scan key of the scanning apparatus such that the scanning apparatus scans the document 1 at step S606. Then, the scanning apparatus scans the specific area of the document according to the above-described method.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations should be apparent to those skilled in the art.

1. A method for scanning a specific area of a document placed on a document stand in a flat-bed type scanning apparatus, the method comprising the steps of:
storing a specific scanning area input by a coordinate input means of the flat-bed type scanning apparatus;
determining whether scanning has been initiated;
measuring a document size by performing scanning and storing the same if scanning is being performed for the specific area;
calculating an area to be actually scanned, from the stored scanning area and the document size; and
scanning an area of the document.

2. The method as claimed in claim 1, wherein the step of storing the specific scanning area comprises the steps of:
determining whether the scanning apparatus is in a specific area designating mode; and
with the front side of the document facing up and aligned to a setting reference point of the document stand, reading coordinates of a starting point and an ending point of a horizontal area and coordinates of a starting point and an ending point of a vertical area in the specific area to be scanned, from a ruler installed in the document stand, and storing the coordinates input by the coordinate input means, in Xstart, Xend, Ystart, and Yend, respectively.

3. The method as claimed in claim 1, wherein the step of measuring and storing the document size comprises the steps of:
determining whether the scanning apparatus is in a specific area designation mode;
with the back of the document facing up and aligned to a setting reference point of the document stand, storing a document image after pre-scanning the document;
calculating the document size by detecting an edge from the stored document image; and
storing the calculated document size in a DocXSize and a DocYSize, respectively.

4. The method as claimed in claim 1, wherein the step of calculating the area to be scanned is performed by the following formula, in which:
X Scan Start Position=Xstart;
X Scan Size=Xend−Xstart;
Y Scan Start Position=DocYSize−Yend; and
Y Scan Size=Yend−Ystart

5. The method as claimed in claim 1, wherein the step of calculating the area to be scanned is performed by the following formula, in which:
X Scan Start Position=DocXSize−Xend;
X Scan Size=Xend−Xstart;
Y Scan Start Position=Ystart; and
Y Scan Size=Yend−Ystart.

6. The method as claimed in claim 1, wherein the step of performing actual scanning comprises the steps of:
moving a scanning module of the flat-bed type scanning apparatus to a scanning start position (X Scan Start Position);
scanning an image of a document using a scanning module;
storing a scanned image; and
determining whether the scanning module is positioned at a scanning termination position.

7. An apparatus for scanning a specific area in a scanning apparatus of a specific area of a document, comprising:
a scanning module adapted to scan the document in the scanning apparatus;
a memory adapted to store the scanned document;
a printing module adapted to print the document; and
a controller adapted to store a specific scanning area input by a coordinate input means of the scanning apparatus, determine whether scanning has been initiated, measure a document size by performing scanning and storing the same if scanning is being performed for the specific area, calculate an area to be scanned, from the stored scanning area and the document size; and scan an area of the document.

8. The apparatus as claimed in claim 7, wherein the controller is further adapted to determine whether the scanning apparatus is in a specific area designation mode, and with the front side of the document facing up and aligned to a setting reference point of the document stand, read coordinates of a starting point and an ending point of a horizontal area and coordinates of a starting point and an ending point of a vertical area in the specific area to be scanned, from a ruler installed in the document stand, and storing the coordinates input by the coordinate input means, in Xstart, Xend, Ystart, and Yend, respectively.

9. The apparatus as claimed in claim 7, wherein the controller is further adapted to determine whether the scanning apparatus is in a specific area designation mode, store a document image after pre-scanning the document with the back of the document facing up and aligned to a setting reference point of the document stand, calculate the document size by detecting an edge of the stored document image, and store the calculated document size in a DocXSize and a DocYSize, respectively.

10. The apparatus as claimed in claim 7, wherein the controller is further adapted to calculate the area to be scanned is performed using the following formula, in which:
X Scan Start Position=Xstart;
X Scan Size=Xend−Xstart;
Y Scan Start Position=DocYSize−Yend; and
Y Scan Size=Yend−Ystart

11. The apparatus as claimed in claim 7, wherein the controller is further adapted to calculate the area to be scanned is performed using the following formula, in which:
X Scan Start Position=DocXSize−Xend;
X Scan Size=Xend−Xstart;
Y Scan Start Position=Ystart; and
Y Scan Size=Yend−Ystart.

12. The apparatus as claimed in claim 7, wherein the controller is further adapted to move a scanning module of the flat-bed type scanning apparatus to a scanning start position (X Scan Start Position), scan an image of a document using the scanning module, store a scanned image, and determine whether the scanning module is positioned at a scanning termination position.
